(19) United States
(12) Patent Application Publication
(10) Pub. No.: US 2026/0225799 A1
(43) Pub. Date: Aug. 6, 2026

(54) WASTE CONTAINERS

(71) Applicant: Lime Track Ltd., Cranleigh Surrey (GB)

(72) Inventors: Andrew King, Cranleigh Surrey (GB); Detlef-Cord Schneider, London (GB)

(73) Assignee: Lime Track Ltd., Cranleigh Surrey, EN (GB)

(21) Appl. No.: 19/151,547

(22) PCT Filed: Feb. 6, 2024
(86) PCT No.: PCT/GB2024/050316

§ 371 Date: Jul. 28, 2025

(30) Foreign Application Priority Data
Feb. 6, 2023 (GB) 2301670.2

(51) Int. Cl. B65F 1/08; B65F 1/14; B65F 1/16

(52) U.S. Cl. CPC B65F 1/08; B65F 1/1473; B65F 1/1615; B65F 2210/108; B65F 2210/128; B65F 2210/172; B65F 2210/184

(57) ABSTRACT

A load-sensing assembly for a waste container that has walls and a mouth, the assembly including a plurality of support points that are supported, in use, on the waste container. A liner is suspended, in use, from the support points, and a lid is arranged to close the liner, with the liner extending below the support points and provides a volume to receive waste. The load-sensing assembly further includes at least one load cell for sensing a load between the liner and the support points. A waste container is provided with the load-sensing assembly, in which the support points are supported on the waste container and the liner is suspended from the support points, with a space between the liner and the waste container such that the waste container does not affect sensing of the load cell.

This invention relates to waste containers, and is concerned particularly although not exclusively with assemblies for segregated waste and recycling containers to monitor their use.

In the context of this specification, the term ‘waste’ includes waste for disposal and waste for recycling.

An estimated one-third of all the food produced in the world goes to waste. That equates to about 1.3 billion tons of food waste, with a large proportion of this waste being thrown away by both hospitality and non-hospitality businesses. A considerable proportion of this food waste will end up in a landfill site, where it rots and releases carbon dioxide and other harmful gases such as methane. Methane is a powerful greenhouse gas that causes damage to the ozone layer, therefore damaging the environment and contributing to climate change.

For households in the UK, waste collections are managed by local councils. However, for businesses, the business owner must arrange for waste collections, and must therefore ensure compliance with regulations.

The UK Environment Act 2021 states that from 2023-24 local authorities may be legally required to collect domestic food waste separately. By 2024-25, businesses will be expected to separate their food waste and digitally track any collections. DEFRA, The Department for Environment, Food and Rural Affairs, in their consultation of June 2022, announced a need for accurate and auditable waste reporting. DEFRA plan to make it mandatory for businesses to separate out food waste from other types of waste, with the overarching aim being to overhaul waste and recycling legislation. But any proposed solutions to this problem must be intuitive for full compliance. The aim being to simplify waste collection systems to improve recycling rates.

One of the main issues with food waste management is in the collection of this waste from multiple businesses and therefore multiple collection points. Each of these collection points presents a relatively small amount of food waste for waste collection vehicles to collect on a regular basis. These waste collection companies strive to prevent too many dead miles, and to improve collection economics. Most non-hospitality businesses are thought to generate at least 1-5 kilograms of food waste a week, with typical waste items being tea bags, coffee grounds and lunchtime leftovers. Restaurants, schools, hospitals, hotels, public houses and other catering businesses are thought to generate more, averaging around 40 kilograms per week. Food manufacturing plants are likely to generate considerably more.

Once food waste has been collected, there are a number of treatment technologies in operation that aim to reprocess the waste to generate renewable energy, and even to produce bio-fertiliser for use in agriculture. It is thought that landfill should be the last resort, and therefore the collection infrastructure needs to provide an efficient, economical and intuitive solution for all business owners. Businesses should strive to be compliant to the incoming changes to the law before legislation forces them to do so.

Initiatives have been proposed that go some way towards reducing the quantity of food waste, encouraging correct processing of any collected food waste, and making use of this waste as a source of renewable energy. But issues with waste segregation and economic aggregation make any new scheme a challenge for businesses to get involved. Any systems must be as easy as possible to implement, with employees being encouraged to see the environmental benefits. Legislation may introduce mandatory reporting of food waste data, forcing businesses to be more transparent about how much food waste they are producing, and how they are disposing of this amount. There are likely to be fines and penalties for businesses that refuse to comply with the legislation. Any schemes should also address the likelihood of waste contamination or fly tipping (intentional and unintentional) by providing some form of access control.

Whilst this is the current situation in the UK, similar proposals are being put forward in other countries of the world, with environmental concerns being a major global issue. There is an increasing trend throughout the world to have systems in place that charge for refuse collection based on the weight of the refuse being collected.

Waste and recycling containers, also known as wheelie bins, trash cans, garbage bins or refuse containers, typically come in capacities ranging from 90 to 1100 litres and are generally colour coded as an aid to the separation of refuse. The colour coding may be throughout the body of the bin, just the lid, or both bin body and lid. Most waste containers in a country are of a standard size, and are provided with required elements to allow a lifting mechanism on a commercial refuse or recycling vehicle to lift the container and tip the contents into the back or top of the vehicle for emptying purposes.

The prior art shows a number of devices which attempt to address these needs in various ways.

GB 2 560 346 (O'Rourke et al) discloses a domestic wheelie bin that comprises a means for weighing the contents. The contents data may then be transmitted to a display mounted on the bin, preferably incorporated into a lid lock, or wirelessly transmitted to a remote receiver. The weight of the refuse within the wheelie bin may be determined by a plurality of load sensors located between the base and the body sections wherein the data is then transmitted to a controller unit to calculate the weight of the bin contents. Whilst this goes some way towards calculating the weight of the wheelie bin and the contents, it is not a proposal for non-domestic food waste and recycling containers. Any external mass, such as snow, ice or a temporary object placed on the bin, will compromise the measured (inferred) contents weight. This system would also require that every dwelling be provided with a new intelligent wheelie bin, and therefore the existing wheelie bins would likely be redundant and scrapped, which would go against the main aim of addressing the issue of climate change.

US 2022 366 380 (RTS Recyclebank LLC) discloses an incentive based waste reduction system, comprising a collection means with a load-determining device, that obtains a quantifiable measure of waste material from an entity. The system rewards a business that deposited the load, whilst Information about the waste material is transmitted to a host server which performs actions based on the received information, including reconfiguring a deployment scheme of trucks to routes to save resources. Whilst this system goes some way towards an intuitive means of waste collection from multiple businesses and/or dwellings, it again requires the use of special collection bins, rendering any existing containers redundant. The device is mounted to the collection truck, rather than to the bin itself.

Whilst the prior art appears to address the issue of waste containers with integrated means to infer the weight of a deposited load, and to transmit the data wirelessly to a central hub for invoicing, and for determining intuitive collection routes, they all require full replacement of existing waste containers for every business or home owner. Whilst attempting to address the issue of refuse collection vehicles having to visit multiple locations to collect small loads of waste by using the weight data obtained to plan an efficient collection route, they do not propose systems to combine waste from multiple businesses and/or dwellings to maximise collection efficiency, whilst still being able to determine the quantity of waste deposited by each of these businesses/dwellings.

Preferred embodiments of the present invention aim to provide a refuse and recycling collection system that reduces ‘dead miles’ or ‘expensive stops’ for collection vehicles by avoiding multiple small collections from multiple locations and avoiding visits to empty bins, whilst still providing means to identify users of the system, and quantifying any material deposited by that user. Preferred embodiments also aim to provide an improved means of sensing the load deposited within a waste and recycling container, and in particular a food waste container, that is suitably robust to withstand the emptying process into collection vehicles, and sufficiently sealed so as not to be affected by food waste. Preferred embodiments aim to provide an improved means of adapting existing waste containers into load sensing containers, to prevent the need to replace all existing waste and recycling containers in circulation, and the tooling to manufacture these containers, rendering them redundant.

According to a first aspect of the present invention, there is provided a load-sensing assembly for a waste container that has walls and a mouth, the assembly comprising:
a plurality of support points that are supported, in use, on the waste container;
a liner that is suspended, in use, from said support points; and
a lid that is arranged to close the liner: wherein:
the liner extends below said support points and provides a volume to receive waste; and
the assembly comprises at least one load cell that is arranged to sense load between the liner and said support points.

Preferably, said support points are provided on a frame that is supported, in use, on the mouth of the waste container.

Preferably, the frame, liner and lid are substantially rectangular.

Preferably, at least one said load cell is provided at a corner of the rectangle.

Preferably, a respective said load cell is provided at 2, 3 or 4 corners of the rectangle.

Said support points may be provided by a plurality of respective brackets that, in use, are mounted on the waste container.

Preferably, at least one said load cell is provided on a respective one of said brackets.

The load-sensing assembly may further comprise electronic components that are potted and at least one of said brackets may have a recess in which the potted electronic components are located.

Preferably, the liner is elongate to fit inside an upright waste container.

Preferably, the lid is configured to be pivotally mounted at one side on a waste container.

Preferably, the lid is provided with locking elements that in use are mounted on a waste container.

Preferably, the lid incorporates a stiffening panel.

Preferably, the load-sensing assembly further comprises electronic components that are configured to receive an output from the or each load cell and derive a weight measurement therefrom.

Preferably, the load-sensing assembly further comprises an audible and/or visible indicator configured to indicate information to a user.

Preferably, the load-sensing assembly further comprises a user input configured to receive control and/or data input from a user.

Preferably, the load-sensing assembly further comprises a communication module configured to provide communication between the load-sensing assembly and a remote device.

Preferably, the load-sensing assembly further comprises a solar panel configured to provide electrical charge that is stored and/or used in the load-sensing assembly.

Preferably, at least one of the electronic components, display, user input, communication module and solar panel is mounted in the lid.

Preferably, the liner is rigid or semi-rigid.

Preferably, the liner has a rounded base.

Preferably, the load-sensing assembly further comprises a limiter arranged to limit opening of the lid to less than 90, 80 or 70 degrees relative to the mouth of the waste container.

Preferably, the limiter is arranged to limit opening of the lid to substantially 60 degrees relative to the mouth of the waste container.

The invention extends to a waste container provided with a load-sensing assembly according to any of the preceding aspects of the invention, wherein said support points are supported on the waste container and the liner is suspended from the support points, with a space between the liner and the waste container such that the waste container does not affect sensing of the load cell.

Preferably, said brackets are mounted on at least one of the walls of the waste container.

Preferably, said walls of the waste container define at least one corner and at least one of said brackets is located in a respective said corner.

Preferably, the waste container is provided with wheels for transport.

The invention extends to a method of adapting a waste container to provide load-sensing, including the step of fitting to the waste container a load-sensing assembly according to any of the preceding aspects of the invention, to provide a waste container as above.

For a better understanding of the invention and to show how embodiments of the same may be carried into effect, reference will now be made, by way of example, to the accompanying diagrammatic drawings, in which:

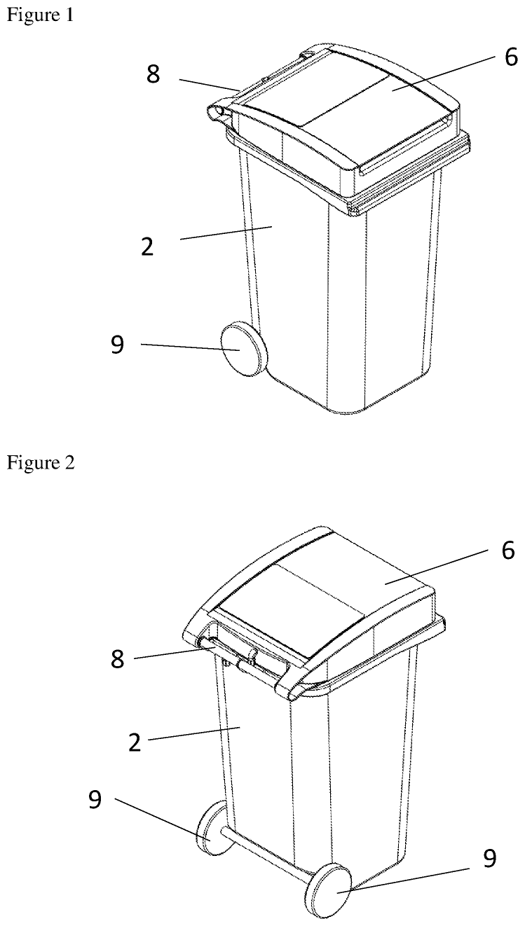

FIG. 1 shows an isometric view of a waste or recycling container with a lid joined to the waste container by a hinge, the lid forming part of a load sensing assembly for said waste container;

FIG. 2 shows a further isometric view of the waste container of FIG. 1, showing the lid hingedly mounted to the waste container and in a closed position, and a typical arrangement of wheels mounted to the waste container;

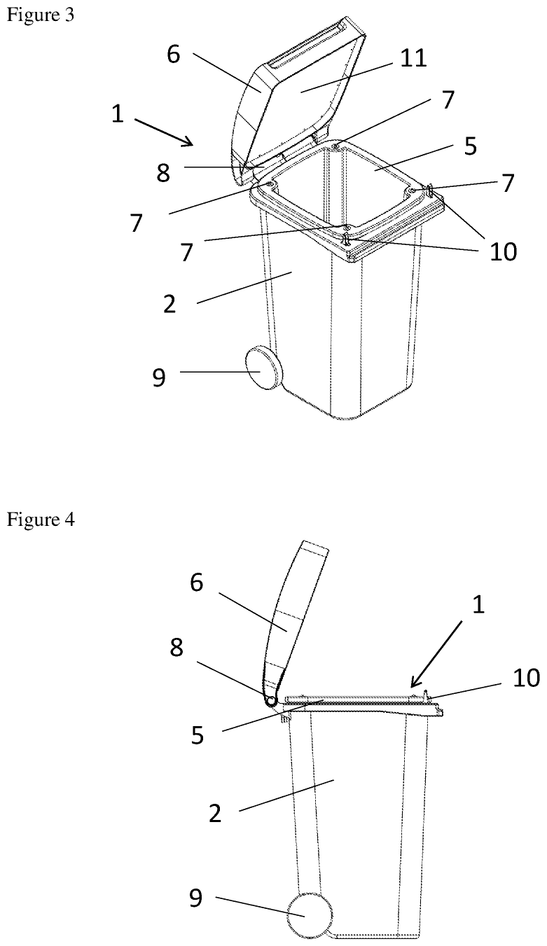

FIG. 3 shows the waste container of FIG. 1, showing the lid in an open position, and showing one embodiment of a liner for the waste container supported on a frame by a plurality of load cells;

FIG. 4 shows a side view of FIG. 3, showing one embodiment of a lock catch within a rim of the waste container for engaging with the lid and locking the lid in a closed position;

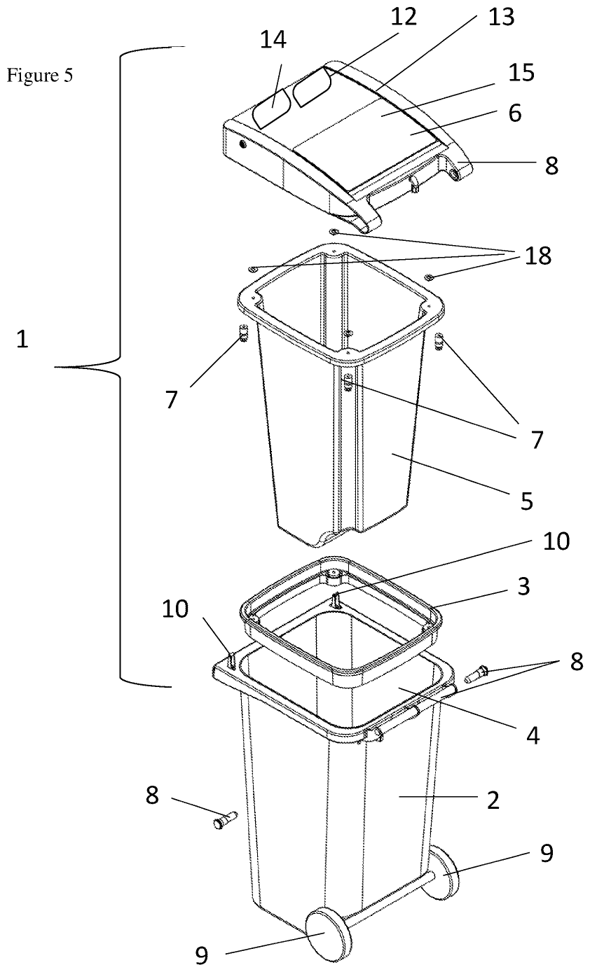

FIG. 5 shows in exploded view one possible embodiment of a load sensing assembly installed within a typical waste container, showing a frame that sits within a mouth of the waste container, a liner being suspended from the frame by load cells;

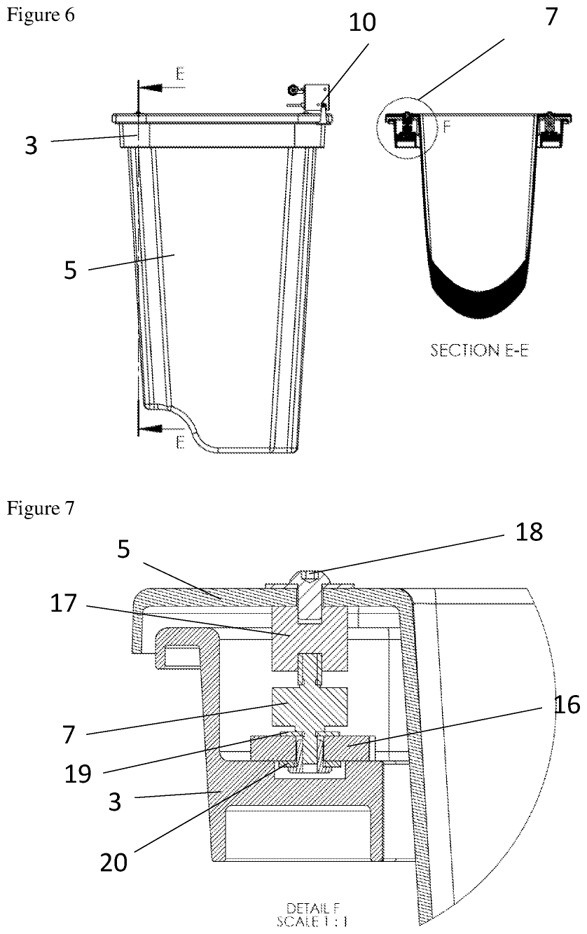

FIG. 6 shows the liner in side view, showing the lock catch for engaging the lid, and a section E-E through one of the load cells upon which the liner is suspended;

FIG. 7 shows a close up view of the section E-E through the load cell, showing the liner suspended on the frame through the load cell;

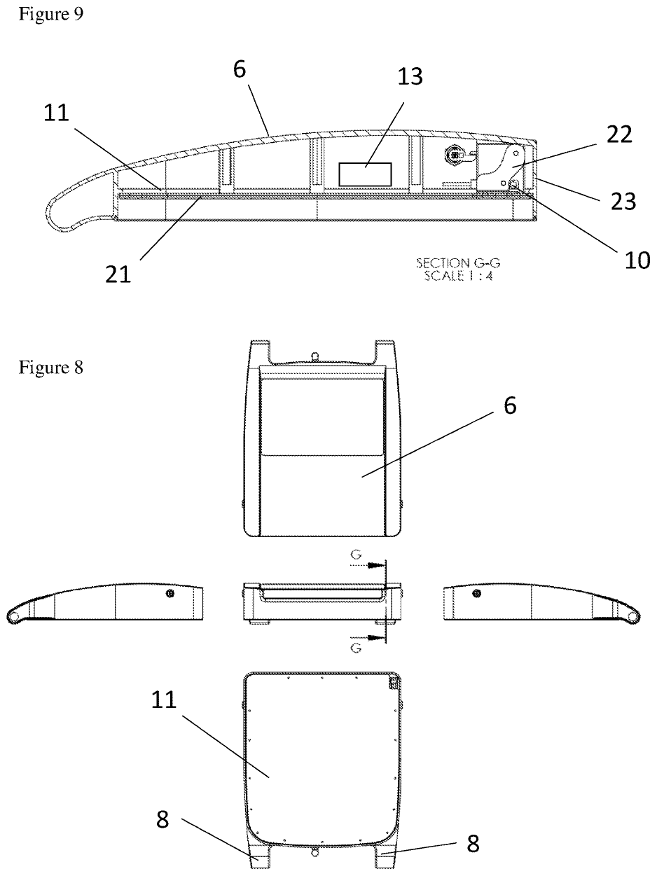

FIG. 8 shows a Multiview projection of one possible embodiment of the lid, showing a reinforcing plate within an underside of the lid, and a section line G-G through one side of the lid;

FIG. 9 shows section G-G through one side of the lid showing one possible embodiment of lock for locking the lid in a closed position;

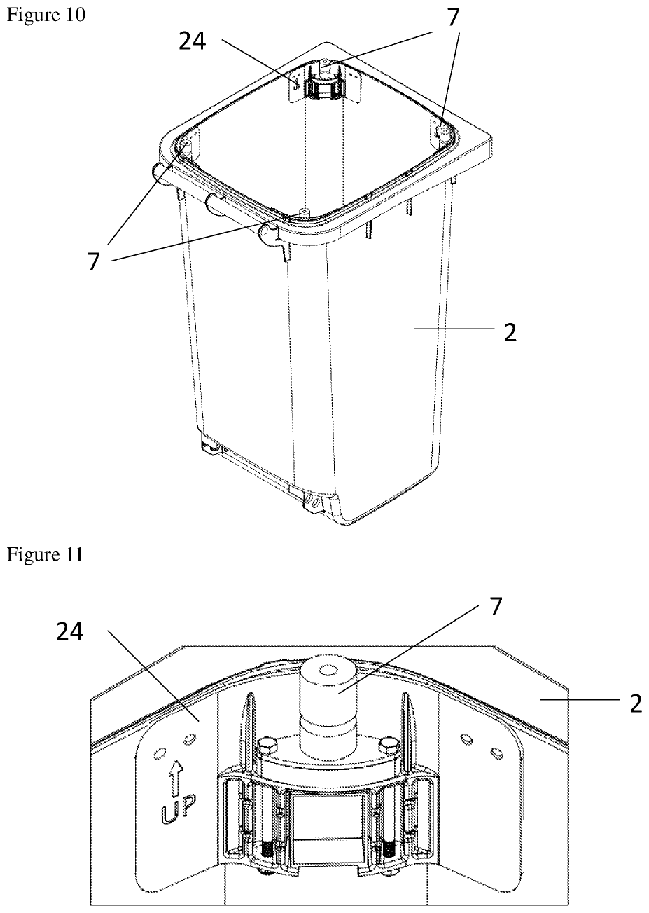

FIG. 10 shows the waste container body of FIG. 1 in isometric view, showing an alternative arrangement of corner brackets for supporting a plurality of loads cells;

FIG. 11 shows the corner bracket of FIG. 10 in close up view, mounted to the side wall of the waste container body;

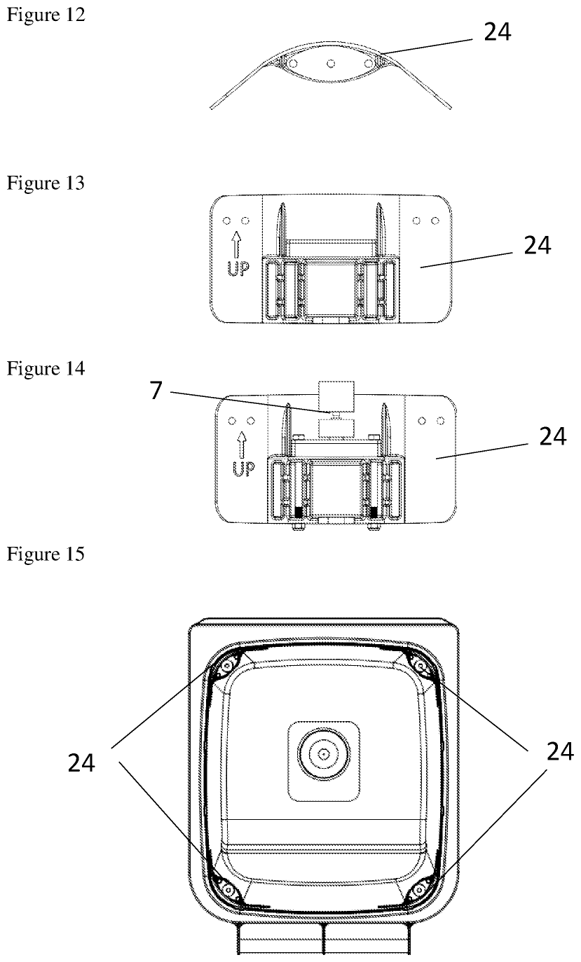

FIG. 12 shows the corner bracket of FIG. 11 in plan view, without the load cell;

FIGS. 13 and 14 show the corner bracket in front view, with FIG. 13 without load cell, and FIG. 14 with load cell configured to support the liner;

FIG. 15 shows a plan view of FIG. 10, showing the corner brackets within all four uppermost corners of the waste container;

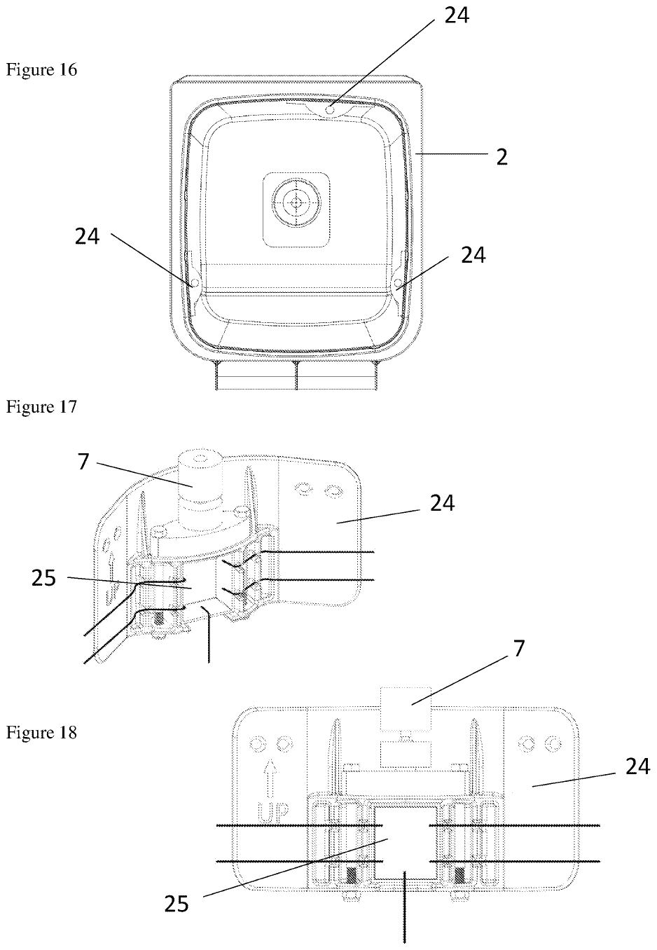

FIG. 16 shows an alternative arrangement of brackets for supporting a load cell, where the brackets are mounted to the sides of the waste container body, about the opening, shown in a triangular configuration;

FIG. 17 shows one embodiment of a plug-in electronics box, plugged into the bracket;

FIG. 18 shows a front view of FIG. 17, showing the electronics box plugged into the bracket;

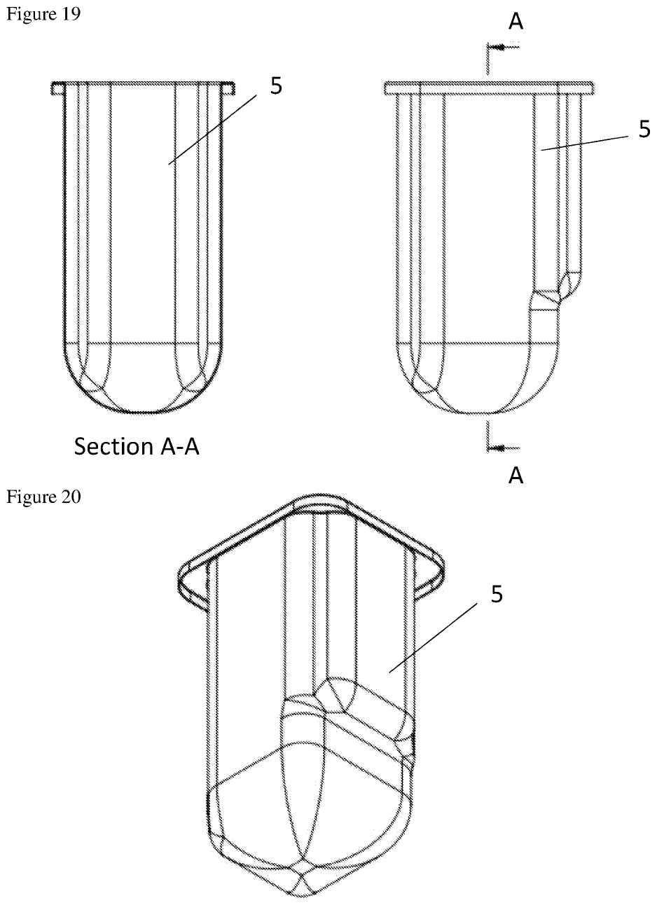

FIG. 19 shows an alternative arrangement of liner, where the bottom of the liner is rounded in configuration, shown in side view and a section view through A-A; and,

FIG. 20 shows an isometric view of the liner of FIG. 19.

In the figures like references denote like or corresponding parts.

FIG. 1 shows a typical waste container 2 that comprises a volume for containing waste, and at least one wheel 9 at the base for assistance when moving the waste container 2, particularly when the volume contains a heavy load. A lid 6 shown in FIG. 1 is a replacement lid for the waste container 2, whereby the lid 6 forms part of a load sensing assembly, the rest of which cannot be seen with the lid 6 in a closed position. The lid 6 is pivotally mounted to the waste container 2 by a hinge 8. The hinge 8 may also be used as a handle for assistance when moving the waste container 2, whereby the waste container 2 can be tipped onto the wheels 9, and pulled or pushed by a person grasping the hinge 8.

The waste container 2 shown is a typical wheelie bin, that may comprise a volume of 80, 120, 140, 240, 360, 500, 660, 770 and 1100 litres. These waste containers 2 typically comprise two wheels 9 for moving the waste container 2 from place to place, such as to a collection vehicle for unloading. Some of the larger waste containers 2 may comprise four wheels 9, not shown.

FIG. 2 shows a rear view of a typical wheelie bin 2, with the lid 6 of the load sensing assembly in a closed position, covering the other parts of the load sensing assembly. FIG. 3 shows the lid 6 in an open position, showing one possible embodiment of liner 5 suspended within the volume of the waste container 2, the liner 5 being configured to float above a frame 3 that surrounds an open mouth 4 of the waste container 2. The liner 5 may comprise a rigid or semi-rigid material. The frame 3 may be bonded or permanently fixed to the waste container 2, sitting on a rim about the mouth 4 of the waste container 2.

Between the frame 3 and the liner 5 sit a plurality of load cells 7. The load cells 7 are mounted to the frame 3. The liner 5 sits on these load cells 7. The load cells 7 are configured to measure a change in weight of contents within the liner 5, such as when a load has been deposited. Loads cells 7 convert a force such as pressure into an electrical signal that can be measured, acting as a force transducer. As the force applied to the load cell 7 increases, the electrical signal changed proportionally. One embodiment comprises four load cells 7, one in each of the corners of the frame 3. The liner 5 is supported on top of the load cells 7 in each corner, and suspended within the waste container 2 in such a position that the liner 5 does not come into contact with any walls of the waste container 2 which would likely impact the measurement of load obtained by the load cells 7.

By positioning the load cells 7 within the corners of the frame 3, they stand less chance of coming into contact with any waste within the liner 5. The frame 3 and the liner 5 may comprise hollow corners within the mouldings to create space in which to house the load cells 7. In this way nothing can interfere with these mounting points where the liner 5 sits on the load cells 7. Where the waste container 2 is for food waste products, the waste deposited tends to comprise messy, liquid products, and foodstuffs that have begun to decompose. Housing the load cells 7 away from this waste helps to prevent the electronics from coming into contact with any substances that may cause damage.

The load sensing assembly 1 is shown as an accessory for an existing waste container 2, where the waste container 2 comprises a shell. The existing lid is removed from the shell to allow for the load sensing assembly 1 to convert the waste container 2 into one that can determine weight of a load deposited, and either store this data, or transmit this data for processing. The frame 3 is installed within the mouth 4 of the waste container 2, and the liner 5 arranged on the top of the load cells 7 within the frame 3. A replacement lid 6 makes use of the existing hinge 8 and the original plugs that make up part of this hinge, to secure the lid 6 to the refuse container 2. The electronic components contained within the lid 6 are operatively connected to the load cells 7 through an armoured conduit between these components and the frame 3 and/or the liner 5 This armoured conduit is likely to run in a channel at the back of the refuse container 2, adjacent to the hinge 8. Alternatively, the cable conduit may run internally. The lid 6 is configured to house all of the electronics, and is therefore provided with a reinforcing plate 11 on the underside to protect these electronics when in use.

Alternatively, the load assembly 1 may be fitted to a new waste container as original equipment.

The waste container 2 is provided with a pair of lock catches 10 at the front of the mouth 4 of the waste container 2. The lock catches 10 may comprise a single lock catch 10 to one side, or a pair of lock catches 10, one on either side as shown. The lock catches 10 are fixed to the existing waste container 2, then the lock catches 10 pass through holes in the lid 6 where they are locked in place with electronic locks. These lock catches 10 are in the outermost corners of a rim of the waste container 2 so that when the waste container 2 is lifted and tipped for emptying into a refuse collection vehicle, the waste contained therein slides out of the mouth 4 of the waste container 2 avoiding contact with these lock catches 10.

FIG. 4 shows a side view of the waste container 2 with the installed load sensing assembly 1, and the lid 6 in an open position. The hinge 8 prevents the lid 6 from opening any further than that shown in the figure, to allow for ease of lifting of the lid 6 and reclosing the lid 6 to deposit waste. This also ensures that the lid 6 will close itself to prevent unauthorised deposits of waste into the waste container 2, and to prevent security from being compromised. The hinge 8 may incorporate, in one or more location, a boss or protrusion that is configured to abut the wall of the waste container 2 when the lid 6 is in the fully open position, preventing the lid 6 from opening further than required. The angle by which the lid 6 may be opened is less than 90, 80 or 70 degrees so that the lid 6 drops back under gravity to close the waste container 2 when not being held.

FIG. 5 shows the load sensing assembly 1 within the waste container 2 in an exploded view. The frame 3, liner 5 and lid 6 make up the load sensing assembly 1. The lid 6 wholly covers the frame 3 and the liner 5, leaving a gap between the lid 6 and the liner 5 so as not to interfere with the load cells 7. The lid 6 houses any electronic components, such as a display 12, and a communication module 13. The lid 6 may also house a user interface 14, and may also house a solar panel 15 for charging the batteries that provide power to the electronic components. To gain access to the waste container 2 a user must unlock the lock catches 10. The user interface 14 may comprise means of identifying a user such as through RFID tags and a tag reader, Near-Field Communication or NFC, wireless token, SMS or text message, or through a pin entry system. The user interface 14 may also determine the type of the waste being deposited, and the location. Or these details may be inputted by the user. The communication module will obtain data for a specific user, take a reading for any load deposited by that user, and wirelessly transmit this to a control centre.

An infographic within the lid 6 will instruct a user as to how to gain entry to the waste container 2. An RFID tag reader, or other secure identification means, will trigger the locks to open if the user is authorised to have access. When the locks are closed again after a deposit has been made, the system is notified, and data obtained for the transaction. This data might include user ID, GPS, time stamp, waste/recycling ID, bin system health and weight deposited.

FIG. 6 shows a side view of the liner 5 that is configured to be the same shape as the waste container 2 that it is to be suspended inside, only with dimensions such that there is a gap between the liner 5 and the walls of the waste container 2 throughout the volume of the waste container 2. Section E-E shows a section through one of the load cells 7, with FIG. 7 showing an enlarged view F of this section view. The load cell 7 is joined to a load cell mount 16 that is secured to the frame 3 with a barrel nut 20. A washer 19 sits between the load cell 7 and the load cell mount 16 to reduce the pressure from the load cell 7 on the load cell mount 16. The load cell 7 is also secured to the liner 5 by a screw 18. A rubber bobbin 17 may sit between the load cell 7 and the liner 5 to isolate the load cell 7 from any vibrations experienced by the liner 5, such as when a load is deposited, when the lid 6 is closed, or when the waste container is moved 2.

The shape of an upper edge of the liner 5 is such that it sits over the top of the upper edge of the frame 3. The load cell assembly 1 arranged in this way ensures accuracy of load measurement across the plurality of load cells 7 used within the assembly. By providing a load cell 7 in each corner of the frame 3, the stability of the liner 5 is maximised, and a change in weight of the liner 5 and any contents can be accurately obtained.

FIG. 8 shows a multi-view of the lid 6 of the load sensing assembly 1 with FIG. 9 showing an enlarged view along section G-G showing the lock assembly 22. The lock 22 may comprise an electrically controlled servo motor bistable lock 23 that is configured to engage with the lock catch 10 of the waste container 2, allowing the lid 6 to be locked and unlocked. This configuration of lock 22 ensures that power is not being used by the lock 22 when the load sensing assembly 1 is not in use, unlike with an electromagnetic lock where the lock would draw power to maintain a locked configuration. The lid 6 is provided with the reinforcing plate 11 and/or a foam gasket 21. All of the electronic components can be attached to the reinforcing plate 11, which can be easily lowered for maintenance. The lid 6 therefore comprises a sheet metal structure, or alternative rigid framework, with plastic cover.

The lock catch 10 may incorporate a manual use mechanism to ensure that access can be gained to the waste container 2 in the event of a power failure. The lock catch 10 may comprise a quarter turn key lock that can be accessed from outside of the waste container 2, that requires a triangle key, for emergency access. Operators of collection vehicles would have means of gaining entry to the waste container 2 through the user interface 14 or through the manual unlatching mechanism, to allow them to empty the contents of the container 2 into their collection vehicle.

The load sensing assembly 1 collects data real-time from all of the waste containers 2 within a network. The system allows for multiple users to gain access to one waste container 2, with each individual use still being linked to a specific user. Waste collection is therefore far more economical, reducing the dead miles and improving bin optimisation (collection economics and initial product cost). The system still allows for accurate and auditable waste reporting, whilst improving collection economics.

As may be seen in the drawings, the container 2, frame 3, liner 5 and lid 6 are of generally rectangular shape in plan view and/or cross-section. In principle, they could be of any polygonal shape including square, or any curved shape including elliptical and circular. The container could be a polygonal shape as its upper part, becoming a curved shape at its lower part, or vice versa.

Typically the container 2, frame 3, liner 5 and lid 6 are of rigid or semi-rigid construction—for example at least partly of a plastics material. The liner 5 may have some flexibility.

FIG. 10 shows an alternative arrangement of load sensing assembly 1 without the frame 3. In this embodiment, a plurality of load cells 7 are each mounted on a bracket 24. In FIG. 10 each corner of the container 2 incorporates a bracket 24, upon which a load cell 7 is supported. The bracket 24 may be adhesively secured to the container 2, or the bracket 24 may be secured by alternative fastenings. The bracket 24 may be secured to the walls of the container 2, rather than to the rim of the container 2.

FIG. 11 shows a close-up view of a corner of the container 2 with a bracket 24 mounted to the corner, and a load cell 7 configured to support the liner 5, not shown. The bracket 24 may comprise various arrangements of supports for the load cell 7 and the accompanying electronics.

FIG. 12 shows the bracket 24 moulded as one piece, with wings either side of the central portion. The wings are configured to flex about the central portion. This flexing ensures that the bracket 24 can be mounted to a number of different radii of containers 2, whilst ensuring a good surface area of contact with the walls of the container 2, particularly where adhesives are used. The curvature or radius of the bracket 24 has been designed to correspond to the maximum radius of the corners of containers 2 that are in existence. The bracket 24 may not fit exactly to the curved corner of the container 2 but the flexible wings allow for the bracket 24 to closely follow the curve of each of these corners, no matter what the angle. The bracket 24 is joined to the container 2 along the wings of the bracket 24. The wings are designed to distort to the angle of the internal walls of the container 2, both the angle in plan view, and also the draft angle of the internal walls of the container 2.

FIG. 13 shows a front view of the bracket 24 without the load cell, and FIG. 14 shows the same front view but with the load cell 7 in position.

FIG. 15 shows one configuration of brackets 24 with one in each corner of the container 2, configured to support the liner, not shown. FIG. 16 shows alternative brackets 24 that are configured to be mounted along substantially straight parts of the container 2 walls. Three of these brackets 24 with load cells 7 are mounted along three of the sides of the container 2, thereby forming a triangular arrangement to support the liner, not shown. Different configurations of corner brackets 24 or side brackets 24 may be used.

FIG. 17 shows one possible embodiment of an electronics box 25 for housing the wires in electronic communication with the load cell 7. The electronics box 25 may conveniently and easily plug into a recess in the bracket 24, protecting the electronic components, wiring, and any joints therebetween whilst allowing for ease of maintenance and replacement. This potting box 25 may house a AD converter, and help with amplifying a signal when a weight has been detected. FIG. 18 shows a front view of the electronics box 25 when plugged into the bracket 24.

The bracket 24 may incorporate notches and tracking, moulded within the bracket or otherwise, that provides cable management, and cable clips.

FIGS. 19 and 20 show an alternative shape of liner 5, where the bottom of the liner 5 is rounded. This liner 5 does not have any corners or edges where dirt and detritus can become lodged thereby making cleaning of the liner 5 far easier. The bottom of this liner 5 may therefore comprise a substantially hemispherical shape. This can be especially beneficial when handling liquid waste product. This rounded or substantially hemispherical shape to the base of the liner 5 promotes ease of cleaning in an upright orientation, inverted orientation or at some angle therebetween.

FIG. 19 shows a side view of the liner 5, with section A-A taken through the liner. FIG. 20 shows the liner 5 in isometric view, with rounded base and shaped to fit a particular style of container 2.

The waste container 2 may incorporate an inclinometer to detect when the waste container 2 is not in an upright configuration. This helps with detecting misuse of the waste container 2 and alerting maintenance providers to visit the waste container 2, whilst also helping to track when the specific waste container 2 has been tipped for emptying.

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivatives) indicates one feature or more that is preferred but not essential.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-28. (canceled)

29. A load-sensing assembly for a waste container having walls and a mouth, comprising:
a plurality of support points supported on the waste container;
a liner that is suspended from said plurality of support points, said liner extending below said plurality of support points and providing a volume for receiving waste;
a lid for closing said liner: and,
a load cell for sensing a load between said liner and said plurality of support points.

30. The load-sensing assembly for a waste container having walls and a mouth according to claim 29, wherein said plurality of support points are provided on a frame that is supported on the mouth of the waste container.

31. The load-sensing assembly for a waste container having walls and a mouth according to claim 30, wherein said frame is of substantially rectangular shape and has said load cell provided at a corner of the substantially rectangular shape of said frame.

32. The load-sensing assembly for a waste container having walls and a mouth according to claim 29, wherein said plurality of support points are a plurality of respective brackets mounted on the waste container.

33. The load-sensing assembly for a waste container having walls and a mouth according to claim 32, wherein at least one said load cell is provided on a respective bracket of said plurality of respective said brackets.

33. The load-sensing assembly for a waste container having walls and a mouth according to claim 32, further comprising an electronic component that is potted, the respective bracket of said plurality of respective said brackets having a recess into which said electronic component is potted.

33. The load-sensing assembly for a waste container having walls and a mouth according to claim 29, further comprising an electronic component mounted on, or inside of, said lid, said electronic component receiving an output from said load cell for deriving a weight measurement therefrom.

34. The load-sensing assembly for a waste container having walls and a mouth according to claim 29, further comprising an audible indicator for indicating information to a user, said audible indicator mounted on, or inside of, said lid of the waste container.

35. The load-sensing assembly for a waste container having walls and a mouth according to claim 29, further comprising an visual indicator for indicating information to a user, said visual indicator mounted on, or inside of, said lid of the waste container.

36. The load-sensing assembly for a waste container having walls and a mouth according to claim 29, further comprising a user input for receiving data input from a user, said user input mounted on, or inside of, said lid of the waste container.

37. The load-sensing assembly for a waste container having walls and a mouth according to claim 29, further comprising a communication module for providing communication between the load-sensing assembly for the waste container and a remote device.

38. The load-sensing assembly for a waste container having walls and a mouth according to claim 29, further comprising a solar panel on an outer surface of the waste container for providing an electrical charge for said load-sensing assembly for the waste container.

39. The load-sensing assembly for a waste container having walls and a mouth according to claim 38, wherein said solar panel is mounted on the outer surface of said lid of the waste container.

40. The load-sensing assembly for a waste container having walls and a mouth according to claim 29, further comprising limiter for limiting opening of said lid to less than 90° relative to the mouth of the waste container.

41. The load-sensing assembly for a waste container having walls and a mouth according to claim 29, wherein said plurality of support points are supported on the waste container and said liner is suspended from said plurality of support points, with a space between said liner and the waste container, so that the waste container does not affect sensing of said load cell.
